(19) United States
(12) Patent Application Publication
(10) Pub. No.: US 2025/0006214 A1
(43) Pub. Date: Jan. 2, 2025

(54) SPEECH SIGNAL PROCESSING METHOD AND DEVICE, ELECTRONIC APPARATUS, EARPHONE, HEARING AID, VEHICLE, AND MEDIUM

(71) Applicants: Xiaomi EV Technology Co., Ltd., Beijing (CN); Beijing Xiaomi Pinecone Electronics Co., Ltd., Beijing (CN)

(72) Inventors: Junnan WU, Beijing (CN); Peng WANG, Beijing (CN); Peng GAO, Beijing (CN); Yujun WANG, Beijing (CN)

(21) Appl. No.: 18/374,432

(22) Filed: Sep. 28, 2023

(30) Foreign Application Priority Data
Jun. 27, 2023 (CN) 202310769102.9

(51) Int. Cl. G10L 21/028

(52) U.S. Cl. CPC G10L 21/028

(57) ABSTRACT

A speech signal processing method includes: acquiring a speech observation signal collected by a speech collection device; pre-separating the speech observation signal to obtain a first pre-separation signal and a second pre-separation signal, wherein a first distance between a sound source of the first pre-separation signal and the speech collection device is different from a second distance between a sound source of the second pre-separation signal and the speech collection device; and performing blind source separation on the speech observation signal according to the first pre-separation signal to obtain a first source speech signal of the sound source of the first pre-separation signal; and performing blind source separation on the speech observation signal according to the second pre-separation signal to obtain a second source speech signal of the sound source of the second pre-separation signal.

### CROSS-REFERENCE TO RELATED APPLICATION

This application claims priority to Chinese Patent Application No. 202310769102.9 filed on Jun. 27, 2023, the entire content of which is incorporated herein by reference.

### BACKGROUND

Sound source separation technology, including separation between different speech signals and separation between speech signals and other signals (music, noise, etc.), is mainly used to solve technical problems caused by the “cocktail party effect”. At present, the most commonly used sound source separation technology is a blind source separation algorithm. Blind source separation, also known as blind signal separation, refers to a process of separating various source speech signals from aliasing signals (speech observation signals) when theoretical model of signals and source signals cannot be accurately known. With the continuous development of neural network technology, artificial intelligence technology has been widely used in fields such as voice, image, network video, natural language processing, signal processing and so on.

In the related art, source speech signals of sound sources at different distances cannot be effectively distinguished, resulting in poor sound source separation performance.

### SUMMARY

The present disclosure relates to the field of speech processing technologies, and in particular to a speech signal processing method, a speech signal processing device, an electronic apparatus, an earphone, a hearing aid, a vehicle, and a medium.

A speech signal processing method according to embodiments of a first aspect of the present disclosure includes: acquiring a speech observation signal collected by a speech collection device; pre-separating the speech observation signal to obtain a first pre-separation signal and a second pre-separation signal, in which a first distance between a sound source of the first pre-separation signal and the speech collection device is different from a second distance between a sound source of the second pre-separation signal and the speech collection device; and performing blind source separation on the speech observation signal according to the first pre-separation signal to obtain a first source speech signal of the sound source of the first pre-separation signal; and performing blind source separation on the speech observation signal according to the second pre-separation signal to obtain a second source speech signal of the sound source of the second pre-separation signal.

An electronic apparatus according to embodiments of a second aspect of the present disclosure includes a memory, a processor, and a computer program stored in the memory and capable of being run on the processor, in which, when the computer program is executed, the processor is configured to: acquire a speech observation signal collected by a speech collection device; pre-separate the speech observation signal to obtain a first pre-separation signal and a second pre-separation signal, in which a first distance between a sound source of the first pre-separation signal and the speech collection device is different from a second distance between a sound source of the second pre-separation signal and the speech collection device; and perform blind source separation on the speech observation signal according to the first pre-separation signal to obtain a first source speech signal of the sound source of the first pre-separation signal; and perform blind source separation on the speech observation signal according to the second pre-separation signal to obtain a second source speech signal of the sound source of the second pre-separation signal.

An earphone according to embodiments of a third aspect of the present disclosure includes a processor, and a memory for storing instructions executable by the processor, in which the processor is configured to: acquire a speech observation signal collected by a speech collection device; pre-separate the speech observation signal to obtain a first pre-separation signal and a second pre-separation signal, in which a first distance between a sound source of the first pre-separation signal and the speech collection device is different from a second distance between a sound source of the second pre-separation signal and the speech collection device; and perform blind source separation on the speech observation signal according to the first pre-separation signal to obtain a first source speech signal of the sound source of the first pre-separation signal; and perform blind source separation on the speech observation signal according to the second pre-separation signal to obtain a second source speech signal of the sound source of the second pre-separation signal.

### BRIEF DESCRIPTION OF DRAWINGS

The above-mentioned and/or additional aspects and advantages of the present disclosure will be apparent and readily understood from the following description of embodiments taken in conjunction with the accompanying drawings.

FIG. 1 is a flow chart of a speech signal processing method according to an embodiment of the present disclosure.

FIG. 2 is a flow chart of a speech signal processing method according to another embodiment of the present disclosure.

FIG. 3 is a schematic diagram of a speech signal processing application in an embodiment of the present disclosure.

FIG. 4 is a flow chart of a speech signal processing method according to another embodiment of the present disclosure.

FIG. 5 is a flow chart of a speech signal processing method according to another embodiment of the present disclosure.

FIG. 6 is a schematic diagram of a speech signal processing device according to an embodiment of the present disclosure.

FIG. 7 is a block diagram of an electronic apparatus configured to implement embodiments of the present disclosure.

FIG. 8 is a functional block diagram of a vehicle according to an embodiment of the present disclosure.

### DETAILED DESCRIPTION

Embodiments of the present disclosure are described in detail below, examples of which are illustrated in the accompanying drawings. The same or similar reference numerals represent the same or similar elements throughout the descriptions. The embodiments described below with reference to the accompanying drawings are illustrative, only for explaining the present disclosure, and cannot be construed as limiting the present disclosure. On the contrary, the embodiments of the present disclosure include all changes, modifications and equivalents that fall within the spirit and connotation of the appended claims.

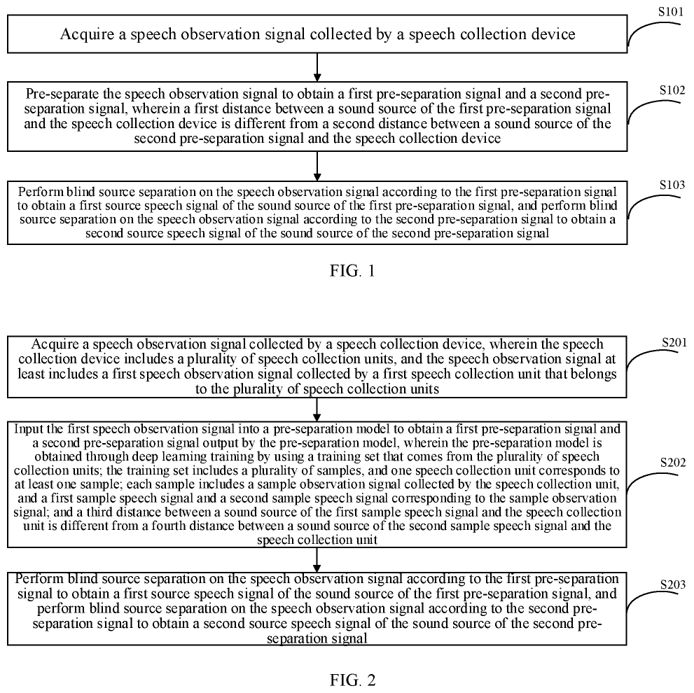

FIG. 1 is a flow chart of a speech signal processing method according to an embodiment of the present disclosure.

This embodiment is illustrated by configuration of a speech signal processing method in a speech signal processing device. In the embodiment, the speech signal processing method can be configured in the speech signal processing device that may be arranged in a server or in an electronic apparatus, which is not limited in embodiments of the present disclosure.

For example, the speech signal processing method in the embodiment may be configured in the electronic apparatus. The electronic apparatus may be a hardware apparatus with various operating systems, such as a smart phone, a tablet computer, a personal digital assistant, an e-book, and a vehicle-mounted apparatus. The electronic apparatus may also be a hearing aid, an earphone, a telephone device, and a sound reinforcement system, which will not be limited in the present disclosure.

It should be noted that an executive body for embodiments of the present disclosure may be, for example, a central processing unit (CPU) in a server or an electronic apparatus in terms of hardware, and may be, for example, a related background service in a server or an electronic apparatus in terms of software, which will not be limited in the present disclosure.

As shown in FIG. 1, the speech signal processing method includes the following steps.

In S101, a speech observation signal collected by a speech collection device is acquired.

A device capable of collecting and picking up speech signals is referred to as the speech collection device. The speech collection device may be, for example, a speech collection unit, such as a microphone. Alternatively, the speech collection device may be, for example, a speech collection array composed of several speech collection units that are arranged orderly and are for example, microphones. The present disclosure will not be limited thereto.

In some embodiments, the speech observation signal is a sound signal collected by a speech collector, which will not be limited in the present disclosure.

In some embodiments, the speech observation signal is one speech observation signal collected separately by the speech collection device. In a case where the speech collection device includes a plurality of speech collection units, the speech observation signal may also include speech observation signals correspondingly collected by the speech collection units, which will not be limited in the present disclosure.

In S102, the speech observation signal is pre-separated to obtain a first pre-separation signal and a second pre-separation signal, in which a first distance between a sound source of the first pre-separation signal and the speech collection device is different from a second distance between a sound source of the second pre-separation signal and the speech collection device.

In some embodiments, after acquiring the speech observation signal collected by the speech collection device, the speech observation signal is pre-separated first, and different speech signals obtained by the pre-separation may be referred to as the first pre-separation signal and the second pre-separation signal, which will not be limited in the present disclosure.

In some embodiments, the speech observation signal may be pre-separated based on distance, to identify speech signals from the speech observation signal, which are obtained through sound signal collection performed on source speech signals of sound sources at different distances, which will not be limited in the present disclosure.

In some embodiments, the distance refers to a distance between the sound source and the speech collection device, which will not be limited in the present disclosure.

In some embodiments, the speech observation signal is pre-separated to obtain the first pre-separation signal and the second pre-separation signal, and the first distance between the sound source of the first pre-separation signal and the speech collection device is different from the second distance between the sound source of the second pre-separation signal and the speech collection device, which will not be limited in the present disclosure.

In some embodiments, the first distance between the sound source of the first pre-separation signal and the speech collection device is a relatively short distance, and the second distance between the sound source of the second pre-separation signal and the speech collection device is a relatively long distance. Alternatively, the first distance between the sound source of the first pre-separation signal and the speech collection device is a relatively long distance, and the second distance between the sound source of the second pre-separation signal and the speech collection device is a relatively short distance, which will not be limited in the present disclosure.

In some embodiments, before blind source separation is performed, the speech observation signal is pre-separated based on a pre-separation module to obtain the first pre-separation signal and the second pre-separation signal. Since the first pre-separation signal and the second pre-separation signal are obtained based on distance separation, the first distance between the sound source of the first pre-separation signal and the speech collection device is different from the second distance between the sound source of the second pre-separation signal and the speech collection device. Consequently, in a subsequent guidance of the blind source separation based on the first pre-separation signal and the second pre-separation signal, the source speech signals of sound sources at different distances can be effectively distinguished, effectively improving sound source separation performance.

In S103, the blind source separation is performed on the speech observation signal according to the first pre-separation signal to obtain a first source speech signal of the sound source of the first pre-separation signal, and the blind source separation is performed on the speech observation signal according to the second pre-separation signal to obtain a second source speech signal of the sound source of the second pre-separation signal.

The sound source of the first pre-separation signal and the sound source of the second pre-separation signal are different sound sources, and distances from different sound sources to the speech collection device are different.

In some embodiments, after the speech observation signal is pre-separated to obtain the first pre-separation signal and the second pre-separation signal, the first pre-separation signal is used to guide a process of performing the blind source separation on the speech observation signal to obtain the first source speech signal of the sound source of the first pre-separation signal, which will not be limited in the present disclosure.

In some embodiments, after the speech observation signal is pre-separated to obtain the first pre-separation signal and the second pre-separation signal, the second pre-separation signal is used to guide a process of performing the blind source separation on the speech observation signal to obtain the second source speech signal of the sound source of the second pre-separation signal, which will not be limited in the present disclosure.

Therefore, in the embodiment, the speech observation signal collected by the speech collection device is acquired; the speech observation signal is pre-separated to obtain the first pre-separation signal and the second pre-separation signal, in which the first distance between the sound source of the first pre-separation signal and the speech collection device is different from the second distance between the sound source of the second pre-separation signal and the speech collection device; and the blind source separation is performed on the speech observation signal according to the first pre-separation signal to obtain the first source speech signal of the sound source of the first pre-separation signal, and the blind source separation is performed on the speech observation signal according to the second pre-separation signal to obtain the second source speech signal of the sound source of the second pre-separation signal. Since the first pre-separation signal and the second pre-separation signal are obtained based on the distance separation, the first distance between the sound source of the first pre-separation signal and the speech collection device is different from the second distance between the sound source of the second pre-separation signal and the speech collection device. Consequently, in the subsequent guidance of the blind source separation based on the first pre-separation signal and the second pre-separation signal, the source speech signals of sound sources at different distances can be effectively distinguished, effectively improving the sound source separation performance.

Application scenarios of the speech signal processing method in the embodiments of the present disclosure will be illustrated as follows.

Application Scenario A: improved speech function experience of related products in situations using a hearing aid, an earphone, a telephone, an online conference, a sound reinforcement system, a vehicle-mounted device or the like.

For example, a user probably just wants to listen to voice of another person who is talking to the user in front of the user, so a hearing aid function of the hearing aid can effectively voices at different distances to the user by adopting the speech processing method in the embodiments of the present disclosure.

Application Scenario B: call noise reduction during an earphone, a telephone, or an online conference.

For example, during a call, users want a local device such as an earphone and a telephone to only pick up their own speaking voice. As more and more users communicate through online conferences at home, they also hope that conference terminals (usually laptops) only pick up their own speaking voice.

Application Scenario C: acoustic feedback suppression in sound reinforcement systems.

For example, sound reinforcement systems are widely used, and squeaking problems of the sound reinforcement systems can be effectively solved by extracting sound at close range.

Application Scenario D: external noise suppression.

For example, when a car window is open, it is hoped for in-car communication or vehicle-mounted voice interaction that an in-car microphone shields noise or human voice outside the car. Through distance-based sound source separation, the sound outside the car can be recognized as long-distance noise and shielded.

In some embodiments of the present disclosure, the speech collection device includes a plurality of speech collection units; and the speech observation signal includes a first speech observation signal collected by a first speech collection unit that is a member of the plurality of speech collection units. As described above, the speech observation signal is pre-separated to obtain the first pre-separation signal and the second pre-separation signal. In these embodiments, the first speech observation signal can be pre-separated to obtain a first pre-separation signal and a second pre-separation signal, improving the efficiency and rationality of the pre-separation.

In some embodiments of the present disclosure, one speech collection unit is randomly selected from the plurality of speech collection units and serves as the first speech collection unit, which can effectively expand application scenarios and effectively avoid excessive resource consumption caused by the pre-separation.

FIG. 2 is a flow chart of a speech signal processing method according to another embodiment of the present disclosure.

As shown in FIG. 2, the speech signal processing method includes the following steps.

In S201, a speech observation signal collected by a speech collection device is acquired, in which the speech collection device includes a plurality of speech collection units, and the speech observation signal includes a first speech observation signal collected by a first speech collection unit that is a member of the plurality of speech collection units.

In S202, the first speech observation signal is input into a pre-separation model to obtain a first pre-separation signal and a second pre-separation signal output by the pre-separation model. The pre-separation model is obtained through deep learning training by using a training set, and the training set comes from the plurality of speech collection units. The training set includes a plurality of samples, and one speech collection unit corresponds to at least one sample. Each sample includes a sample observation signal collected by the speech collection unit, as well as a first sample speech signal and a second sample speech signal corresponding to the sample observation signal. A third distance between a sound source of the first sample speech signal and the speech collection unit is different from a fourth distance between a sound source of the second sample speech signal and the speech collection unit.

That is, an initial neural network model is trained in advance based on a deep learning method, and the initial neural network model has a function of pre-separating the speech observation signal based on distance. In a training process, when it is determined that the neural network model converges during training, a converged neural network model is taken as the pre-separation model, and the converged neural network model is a neural network model obtained through multiple iterative training of the initial neural network model, which will not be limited in the present disclosure.

The structure of the initial neural network model may flexibly adopt a convolutional neural network (CNN), a long short-term memory network (LSTM) or the like, which will not be limited in the present disclosure.

In some embodiments, the training set is acquired first, and the training set includes the plurality of samples. Each sample includes the sample observation signal collected by the speech collection unit, and the first sample speech signal and the second sample speech signal corresponding to the sample observation signal. The third distance between the sound source of the first sample speech signal and the speech collection unit is different from the fourth distance between the sound source of the second sample speech signal and the speech collection unit, which will not be limited in the present disclosure.

The first sample speech signal and the second sample speech signal refer to speech signals at different distances in the sample observation signal, which will not be limited in the present disclosure.

In some embodiments, the first sample speech signal and the second sample speech signal are obtained by labeling the sample observation signal in advance, and the third distance between the sound source of the first sample speech signal and the speech collection device is different from the fourth distance between the sound source of the second sample speech signal and the speech collection device, which will not be limited in the present disclosure.

In some embodiments, the third distance between the sound source of the first sample speech signal and the speech collection device is a relatively short distance, while the fourth distance between the sound source of the second sample speech signal and the speech collection device is a relatively long distance. Alternatively, the third distance between the sound source of the first sample speech signal and the speech collection device is a relatively long distance, while the fourth distance between the sound source of the second sample speech signal and the speech collection device is a relatively short distance, which will not be limited in the present disclosure.

In some embodiments, a process of obtaining the pre-separation model through deep learning training may refer to relevant techniques, which will not be elaborated herein.

In S203, blind source separation is performed on the speech observation signal according to the first pre-separation signal to obtain a first source speech signal of the sound source of the first pre-separation signal, and blind source separation is performed on the speech observation signal according to the second pre-separation signal to obtain a second source speech signal of the sound source of the second pre-separation signal.

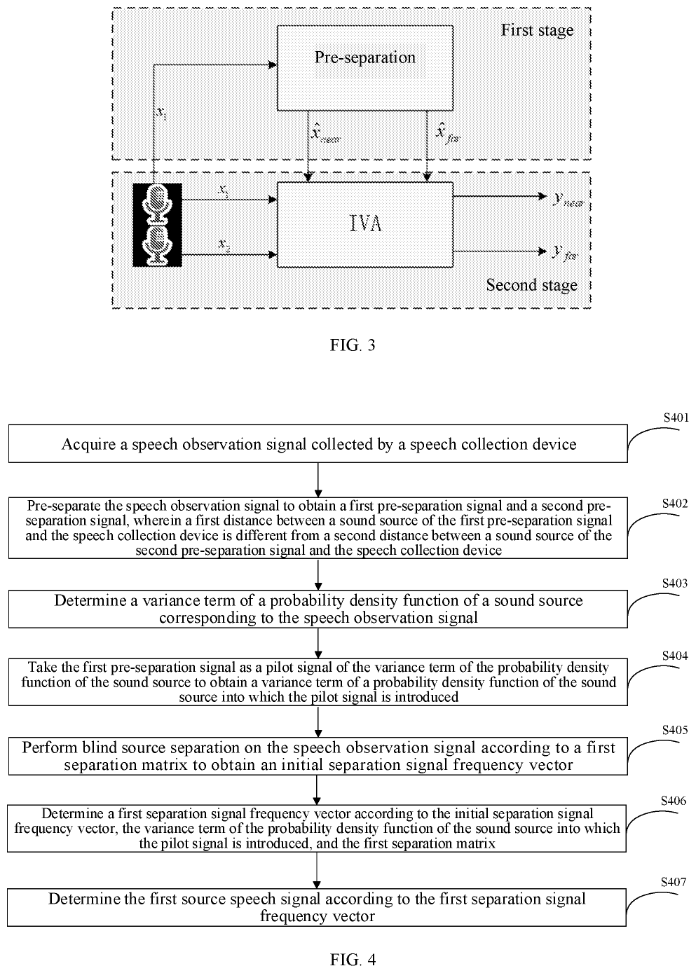

As shown in FIG. 3 that is a schematic diagram of a speech signal processing application in an embodiment of the present disclosure, the speech observation signal is pre-separated in a first stage (a pre-separation stage), and the speech collection device includes two speech collection units, each of which is a microphone, for example. A speech observation signal x₁ collected by a first microphone is pre-separated, and the pre-separation process is realized based on a pre-separation model, into which the speech observation signal x₁ is for example input to obtain a first pre-separation signal \hat{X}ₙₑₐᵣ and a second pre-separation signal \hat{X}_{far}. Then, an independent vector analysis (IVA) algorithm is guided based on the first pre-separation signal \hat{X}ₙₑₐᵣ and the second pre-separation signal \hat{X}_{far} to perform blind source separation on speech observation signals x₁, and x₂ of the speech collection device.

In some embodiments, in a case that the speech collection device includes two speech collection units, and the two speech collection units acquire a speech observation signal x₁ and a speech observation signal x₂, respectively. One of the speech observation signals (e.g., the speech observation signal x₁ or the speech observation signal x₂) is guided based on the first pre-separation signal \hat{X}ₙₑₐᵣ to separate off a source speech signal of a sound source of the first pre-separation signal \hat{X}ₙₑₐᵣ (which may be referred to as a first source speech signal). Alternatively, one of the speech observation signals (e.g., the speech observation signal x₁ or the speech observation signal x₂) is guided based on the second pre-separation signal \hat{X}_{far} to separate off a source speech signal of a sound source of the second pre-separation signal \hat{X}_{far} (which may be referred to as a second source speech signal). The present disclosure will not be limited thereto.

In the first stage of pre-separation, a goal is to obtain a close-range signal (an optional example of the first pre-separation signal) and a long-range signal (an optional example of the second pre-separation signal); a mixed signal to be separated received by a single microphone (an optional example of the first speech collection unit) is input into a pre-separation module; and the close-range signal and the long-range signal are output after preliminary separation. The pre-separation module may be a network model trained by using the deep learning method.

A model training method is illustrated as follows:

$$f ( {X}_{mix} ) \to \{ {\hat{X}}_{near} , {\hat{X}}_{far} \} ;$$

$$loss = Loss \{ {X}_{near} , {X}_{near} \} + Loss \{ {X}_{far} , {X}_{far} \} ;$$

where f represents a separation network; Xₘᵢₓ, Xₙₑₐᵣ, and X_{far} represent a mixed signal to be separated, a clean close-range signal, and a clean long-range signal, respectively; \hat{X}ₙₑₐᵣ, \hat{X}_{far} represent a separated close-range signal and a separated long-range signal, respectively. The above-mentioned signals may be time domain signals, or may be frequency domain signals after short-time Fourier transform. The “Loss” represents a loss function used in training, and any form of loss function may be flexibly used, which will not be limited in the present disclosure. The training set may be generated by simulation or actual recording. The training set mainly consists of multiple close-range signals Xₙₑₐᵣ, multiple long-range signals X_{far}, and Xₘᵢₓ formed by a mixture thereof in room.

It should be noted that the blind source separation is abbreviated as BSS. The blind source separation is a technology that can achieve source signal recovery according to certain criteria by using an observation signal obtained from mixing under the condition that source signals and a mixed system are unknown and based on an assumption that the source signals satisfy mutual independence. In the embodiments of the present disclosure, the speech observation signal collected by the speech collection device is a mixed signal obtained by mixing a plurality of speech signals, and the blind source separation technology can separate the plurality of speech signals according to the speech observation signal.

In the embodiments of the present disclosure, the first pre-separation signal and the second pre-separation signal obtained based on the distance separation is used to guide the blind source separation process. The close-range signal (an optional example of the first pre-separation signal) and the long-range signal (an optional example of the second pre-separation signal) are fixed on corresponding channels by using prior pilot information, which can not only solve technical problems of leakage and distortion in the neural network-based sound source separation technology, but also effectively solve a technical problem that a technology combining beamforming with blind source separation fails to separate source speech signals from sound sources at a same azimuth.

FIG. 4 is a flow chart of a speech signal processing method according to another embodiment of the present disclosure.

As shown in FIG. 4, the speech signal processing method includes the following steps.

In S401, a speech observation signal collected by a speech collection device is acquired.

The speech observation signal may be a speech observation signal collected by any one of a plurality of speech collection units of the speech collection device, such as the speech observation signal x₁ shown in FIG. 3, which will not be limited in the present disclosure.

In S402, the speech observation signal is pre-separated to obtain a first pre-separation signal and a second pre-separation signal, in which a first distance between a sound source of the first pre-separation signal and the speech collection device is different from a second distance between a sound source of the second pre-separation signal and the speech collection device.

The pre-separated speech observation signal may be the speech observation signal x₁ or the speech observation signal x₂ shown in FIG. 3. The first pre-separation signal obtained by separation is used to guide blind source separation on the speech observation signal x₁, which will not be limited in the present disclosure.

This embodiment provides an implementation of performing blind source separation on the speech observation signal according to the first pre-separation signal to obtain a first source speech signal of the sound source of the first pre-separation signal. That is, the first pre-separation signal is fixed on a corresponding channel (e.g., a channel that outputs the speech observation signal x₁ or a channel that outputs the speech observation signal x₂) to effectively separate the source speech signal of the sound source at a distance corresponding to the first pre-separation signal, thus effectively improving the sound source separation performance.

In S403, a variance term of a probability density function of a sound source corresponding to the speech observation signal is determined.

Assuming that there are two sound sources, they are respectively located within and beyond a specified distance, with no limitation on azimuth.

In an embodiment of the present disclosure, a dual-microphone array (which does not limit the form of the speech collection device) is used to receive the speech observation signal, and after short-time Fourier transform, frequency domain representations of a microphone signal (an optional example of the speech observation signal), an original sound source signal, and an estimated sound source signal (an optional example of the source speech signal) are obtained:

X(t,f)=[X₁(t,f),X₂(t,f)]^{T};

S(t,f)=[S₁(t,f),S₂(t,f)]^{T};

Y(t,f)=[Y₁(t,f),Y₂(t,f)]^{T};

where t represents time, f represents frequency, and the superscript T represents vector transposition.

The original sound source signal is received by the microphone after propagation, and may be, for example, mixed and separated in a frequency domain by a convolution mixing system, in which a frequency domain mixing model and a frequency domain separation model are respectively expressed as:

X(ω,n)=A(f)S(t,f);

Y(ω,n)=W(f)X(t,f);

where A(f) and W(f) represent a mixing matrix and a separation matrix, respectively. A blind source separation algorithm is used to estimate the separation matrix W(f) without any prior information, and estimate the sound source signal Y(t,f) (an optional example of the source speech signal) by using a mixed signal X(t,f) (an optional example of the speech observation signal).

In the blind source separation process, assuming that sound sources are independent of each other, an IVA algorithm assumes a multivariate probability density function to make use of correlation between frequencies, which not only preserves internal dependency of each source signal frequency, but also maximizes independence between different sound source signals to effectively avoid arrangement problems, so as to ensure that separated signals are consistent throughout the entire frequency band. On this basis, an objective function of the IVA algorithm is:

$$J ( W ) = - {\sum }_{k = 1}^{2} E [ log p ( {Y}_{k} ( t , f ) ) ] - {\sum }_{f = 1}^{F} log \vert det W ( f ) \vert ;$$

where p(Yₖ(t,f) represents the multivariate probability density function of the sound source; 1≤k≤T, k=1, 2, and T represent the number of frames of the sound signal (the speech observation signal) in the frequency domain; E[ ] represents a mathematical expectation; log represents logarithm; detW(f) represents a determinant of the matrix W(f); ∥ represents modulo; f represents a frequency point marker; and F represents the last frequency point marker.

Assuming that the sound source obeys a time-varying Gaussian distribution, the probability density function p(Yₖ(t,f)) of the sound source satisfies:

$$p ( {Y}_{k} ( t ) ; {σ}_{k}^{2} ( t ) ) ∝ exp ( - \frac{{‖ {Y}_{k} ( t ) ‖}_{2}^{2}}{2 {σ}_{k}^{2} ( t )} ) ;$$

where Yₖ(t) represents normalization of Yₖ(t,f) on the frequency point marker f; σₖ²(t) represents a time-varying variance (variance term) of the probability density function of the sound source; ∥ ∥₂ represents L2 norm, ∥ ∥₂² represents a square of the L2 norm; ∝ represents a label which obeys a certain distribution; 1≤k≤T, k=1,2, and T represent the number of frames of the sound signal (the speech observation signal) in the frequency domain. Based on the probability density function, the IVA solves a frequency replacement problem of the blind source separation.

In some embodiments, determining the variance term of the probability density function of the sound source corresponding to the speech observation signal may be σₖ²(t), which will not be limited in the present disclosure.

In S404, the first pre-separation signal is taken as a pilot signal of the variance term of the probability density function of the sound source to obtain a variance term of a probability density function of the sound source into which the pilot signal is introduced.

In an embodiment of the present disclosure, in order to solve the technical problem of global replacement, the pre-separation signals obtained in the first stages and denoted as Yₚ(t,f)=[Y_{p,1}(t,f), Y_{p,2}(t,f)]^{T}, where Y_{p,1}(t,f) and Y_{p,2}(t,f) are a close-range signal and a long-range signal based on a specific distance, is used to add its energy (signal) to the time-varying variance of the probability density function of the sound source, to obtain a new probability density function:

$$p ( {Y}_{k} ( t ) ; {σ}_{k}^{2} ( t ) ) ∝ exp ( - \frac{{‖ {Y}_{k} ( t ) ‖}_{2}^{2}}{2 [ {σ}_{k}^{2} ( t ) + {γ}^{2} {σ}_{p , k}^{2} ( t ) ]} ) ;$$

where γ represents a weight coefficient of the pre-separation signal (the first pre-separation signal or the second pre-separation signal). When p in σ_{p,k}²(t) is set to 1, it represents the energy of the close-range signal Y_{p,1}(t f) classified by the specific distance. When p in σ_{p,k}²(t) is set to 2, it represents the energy of the long-range signal Y_{p,2}(t,f) classified by the specific distance. In this embodiment, since the first pre-separation signal is fixed on the corresponding channel, p in σ_{p,k}²(t) is set to 1. For the implementation of p in σ_{p,k}²(t) being set to 2, reference may be made to the following embodiments.

In some embodiments of the present disclosure, the variance term of the probability density function of the sound source into which the pilot signal is introduced may be, for example, γ²σ_{p,k}²(t), which will not be limited in the present disclosure.

In S405, blind source separation is performed on the speech observation signal according to a first separation matrix to obtain an initial separation signal frequency vector.

The first separation matrix may be an N^{th} generation separation matrix in the IVA algorithm, where N is an integer greater than zero. When N is 1, the first separation matrix is a random matrix, which will not be limited in the present disclosure.

In some embodiments, the blind source separation is performed on the speech observation signal according to the first separation matrix to obtain a separation signal frequency vector (the meaning of the separation signal frequency vector may refer to the IVA algorithm, which will not be elaborated herein). The separation signal frequency vector is referred to as the initial separation signal frequency vector.

In S406, a first separation signal frequency vector is determined according to the initial separation signal frequency vector, the variance term of the probability density function of the sound source into which the pilot signal is introduced, and the first separation matrix.

The separation signal frequency vector used to determine the first source speech signal is referred to as the first separation signal frequency vector.

In some embodiments, it is determined whether to take the initial separation signal frequency vector as the first separation signal frequency vector based on the objective function of the IVA algorithm, which will not be limited in the present disclosure.

It can be understood that based on the principle of blind source separation algorithm, under the assumption that the first separation signal frequency vector (corresponding to the first source speech signal) and the second separation signal frequency vector (corresponding to the second source speech signal) are independent from each other, the separation signal frequency vector recovery is realized by making separation signal frequency vectors of different source speech signals as independent as possible. There are two steps as follows: first, determining an objective function, and taking the objective function as a standard of judging whether the separation signal frequency vector is close to statistical independence; second, determining an optimization algorithm, and using the optimization algorithm to update a next separation matrix according to a previous separation matrix, to make the separation signal frequency vector close to the standard of statistical independence.

In some embodiments of the present disclosure, when the initial separation signal frequency vector satisfies a preset condition, the initial separation signal frequency vector is taken as the first separation signal frequency vector; when the initial separation signal frequency vector does not satisfy the preset condition, a reference term is updated according to the first separation matrix, and an updated reference term is acquired. The reference term includes the variance term of the probability density function of the sound source into which the pilot signal is introduced, and the first separation matrix is related to the initial reference term. A second separation matrix is determined according to the updated reference term, and blind source separation is performed on the speech observation signal according to the second separation matrix until a separation signal frequency vector obtained by the blind source separation satisfies the preset condition. The separation signal frequency vector obtained is taken as the first separation signal frequency vector. In such a way, the first separation signal frequency vector can be accurately determined, and acquisition of an accurate first source speech signal can be assisted.

In some embodiments, the first separation matrix is determined based on the reference item, and the second separation matrix is determined based on the updated reference item. When the first separation matrix refers to a N^{th} separation matrix, the second separation matrix may refer to a (N+1)^{th} separation matrix, which will not be limited in the present disclosure.

An expression and update of the reference item is as follows:

(1) Updating a weighted covariance matrix Vₖ(f):

$${r}_{k} ( t ) = \sqrt{{\sum }_{f = 1}^{F} {\vert {ω}_{k}^{H} ( f ) X ( t , f ) \vert}^{2}} ;$$

where rₖ(t) represents L2 norm of the first source speech signal.

$${σ}_{p , k}^{2} ( t ) = \frac{1}{F} {\sum }_{f = 1}^{F} {\vert {Y}_{p , k} ( t , f ) \vert}^{2}$$

where ϕ(rₖ(t)) represents a variance estimation value of a k^{th} sound source.

$$ϕ ( {r}_{k} ( t ) ) = \frac{1}{{r}_{k}^{2} ( t ) / F + {γ}^{2} {σ}_{p , k}^{2} ( t )} ;$$

where ϕ(rₖ(t)) represents a coefficient of the weighted covariance matrix after introducing the pilot signal, and ϕ(rₖ(t)) is an optional example of the reference term, which will not be limited in the present disclosure. The reference term includes the variance term γ²σ_{p,k}²(t) of the probability density function of the sound source into which the pilot signal is introduced.

$${V}_{k} ( f ) = \frac{1}{T} {\sum }_{f = 1}^{T} [ ϕ ( {r}_{k} ( t ) ) X ( t , f ) {X}^{H} ( t , f ) ] ;$$

where Vₖ(f) represents the weighted covariance matrix. A new reference term may be calculated according to the first separation matrix based on the above-mentioned formula, and the new reference term is taken as the updated reference term, which will not be limited in the present disclosure.
(2) Updating a separation matrix ωₖ(f):

$${ω}_{k} ( f ) ← {( W ( f ) {V}_{k} ( f ) )}^{- 1} {e}_{k} ;$$

where ωₖ(f) represents one matrix element in the separation matrix, that is, each ωₖ(f) is updated.

$${ω}_{k} ( f ) ← {ω}_{k} ( f ) / \sqrt{{ω}_{k}^{H} ( f ) {V}_{k} ( f ) {ω}_{k} ( f )} ;$$

where eₖ is a 4×1 order unit vector; a n^{th} element is 1; other elements are 0; H represents conjugate transpose; and ( )⁻¹ represents matrix inversion. The second separation matrix may be determined according to the updated reference term based on the formula shown in the above (2), which will not be limited in the present disclosure.

After updating the reference term according to the first separation matrix and acquiring the updated reference term, and determining the second separation matrix according to the updated reference term, the blind source separation is performed on the speech observation signal according to the second separation matrix until the separation signal frequency vector obtained by the blind source separation satisfies the preset condition (for example, the standard of statistical independence), and the separation signal frequency vector obtained is taken as the first separation signal frequency vector.

In S407, the first source speech signal is determined according to the first separation signal frequency vector.

After determining the first separation signal frequency vector that satisfies the standard of statistical independence, the first source speech signal is synthesized according to the first separation signal frequency vector, which will not be limited in the present disclosure.

In this embodiment, the first pre-separation signal is fixed on the corresponding channel, and the source speech signal of the sound source corresponding to the first pre-separation signal is effectively separated, effectively improving the sound source separation performance.

FIG. 5 is a flow chart of a speech signal processing method according to another embodiment of the present disclosure.

As shown in FIG. 5, the speech signal processing method includes the following steps.

In S501, a speech observation signal collected by a speech collection device is acquired.

The speech observation signal may be a speech observation signal collected by any one of a plurality of speech collection units of the speech collection device, such as the speech observation signal x₂ shown in FIG. 3, which will not be limited in the present disclosure.

In S502, the speech observation signal is pre-separated to obtain a first pre-separation signal and a second pre-separation signal, in which a first distance between a sound source of the first pre-separation signal and the speech collection device is different from a second distance between a sound source of the second pre-separation signal and the speech collection device.

The pre-separated speech observation signal may be the speech observation signal x₁ or the speech observation signal x₂ shown in FIG. 3. The first pre-separation signal obtained by separation is used to guide blind source separation on the speech observation signal x₂, which will not be limited in the present disclosure.

This embodiment provides an implementation of performing blind source separation on the speech observation signal according to the second pre-separation signal to obtain a second source speech signal of the sound source of the second pre-separation signal is provided. That is, the second pre-separation signal is fixed on a corresponding channel (e.g., a channel that outputs the speech observation signal x₂ or a channel that outputs the speech observation signal x₁, and channels for separating the first source speech signal and the second source speech signal being different) to effectively separate the source speech signal of the sound source at a distance corresponding to the second pre-separation signal, thus effectively improving the sound source separation performance.

It should be noted that in this embodiment, the second pre-separation signal is fixed to the corresponding channel (e.g., the channel that outputs the speech observation signal x₂ or the channel that outputs the speech observation signal x₁, and channels for separating the first source speech signal and the second source speech signal being different), so that a speech signal processing mode, a way of introducing the pilot signal, the first separation matrix, the second separation matrix, the expression of the reference term, and the terminology interpretation or implementation for determining the second separation matrix according to the updated reference term can refer to the description in the above embodiments, which will not be elaborated herein.

In S503, a variance term of a probability density function of a sound source corresponding to the speech observation signal is determined.

In S504, the second pre-separation signal is taken as a pilot signal of the variance term of the probability density function of the sound source to obtain a variance term of the probability density function of the sound source into which the pilot signal is introduced.

In S505, blind source separation is performed on the speech observation signal according to a first separation matrix to obtain an initial separation signal frequency vector.

In S506, a second separation signal frequency vector is determined according to the initial separation signal frequency vector, the variance term of the probability density function of the sound source into which the pilot signal is introduced, and the first separation matrix.

The separation signal frequency vector used to determine the second source speech signal may be referred to as the second separation signal frequency vector.

In some embodiments of the present disclosure, when the initial separation signal frequency vector satisfies a preset condition, the initial separation signal frequency vector is taken as the second separation signal frequency vector; when the initial separation signal frequency vector does not satisfy the preset condition, a reference term is updated according to the first separation matrix, and an updated reference term is acquired. The reference term includes the variance term of the probability density function of the sound source into which the pilot signal is introduced, and the first separation matrix is related to the initial reference term. A second separation matrix is determined according to the updated reference term, and blind source separation is performed on the speech observation signal according to the second separation matrix until a separation signal frequency vector obtained by the blind source separation satisfies the preset condition. The separation signal frequency vector obtained is taken as the second separation signal frequency vector. In such a way, the second separation signal frequency vector can be accurately determined, and acquisition of an accurate first source speech signal can be assisted.

In S507, a second source speech signal is determined according to the second separation signal frequency vector.

After determining the second separation signal frequency vector that satisfies the standard of statistical independence, the second source speech signal is synthesized according to the second separation signal frequency vector, which will not be limited in the present disclosure.

In this embodiment, the source speech signal of the sound source corresponding to the second pre-separation signal is effectively separated, effectively improving the sound source separation performance.

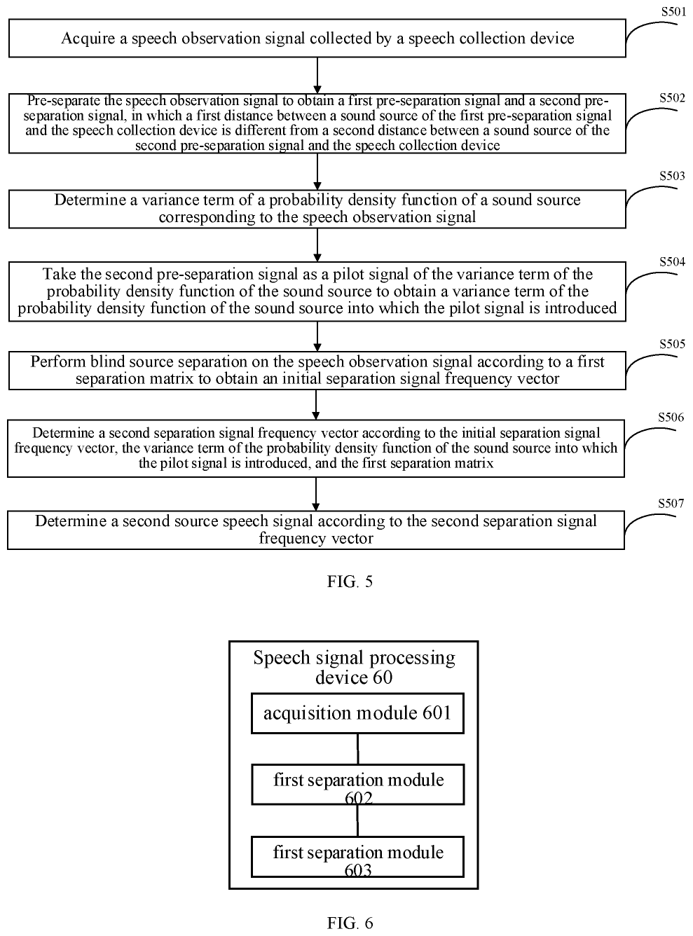

FIG. 6 is a schematic diagram of a speech signal processing device according to an embodiment of the present disclosure.

As shown in FIG. 6, the speech signal processing device 60 includes an acquisition module 601, a first separation module 602, and a second separation module 603. The acquisition module 601 is configured to acquire a speech observation signal collected by a speech collection device. The first separation module 602 is configured to pre-separate the speech observation signal to obtain a first pre-separation signal and a second pre-separation signal, in which a first distance between a sound source of the first pre-separation signal and the speech collection device is different from a second distance between a sound source of the second pre-separation signal and the speech collection device. The second separation module 603 is configured to perform blind source separation on the speech observation signal according to the first pre-separation signal to obtain a first source speech signal of the sound source of the first pre-separation signal, and perform blind source separation on the speech observation signal according to the second pre-separation signal to obtain a second source speech signal of the sound source of the second pre-separation signal.

It should be noted that the above explanation of the speech signal processing method is also applicable to the speech signal processing device in this embodiment, which will not be elaborated herein.

In this embodiment, the speech observation signal collected by the speech collection device is acquired; the speech observation signal is pre-separated to obtain the first pre-separation signal and the second pre-separation signal, in which the first distance between the sound source of the first pre-separation signal and the speech collection device is different from the second distance between the sound source of the second pre-separation signal and the speech collection device; and the blind source separation is performed on the speech observation signal according to the first pre-separation signal to obtain the first source speech signal of the sound source of the first pre-separation signal, and the blind source separation is performed on the speech observation signal according to the second pre-separation signal to obtain the second source speech signal of the sound source of the second pre-separation signal. Since the first pre-separation signal and the second pre-separation signal are obtained based on the distance separation, the first distance between the sound source of the first pre-separation signal and the speech collection device is different from the second distance between the sound source of the second pre-separation signal and the speech collection device. Consequently, in the subsequent guidance of the blind source separation based on the first pre-separation signal and the second pre-separation signal, the source speech signals of sound sources at different distances can be effectively distinguished, effectively improving the sound source separation performance.

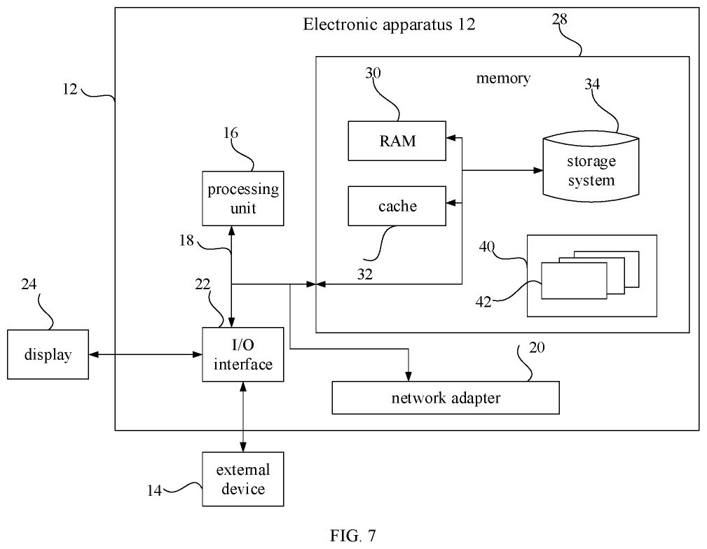

FIG. 7 is a block diagram showing an electronic apparatus suitable for implementing embodiments of the present disclosure. An electronic apparatus 12 shown in FIG. 7 is merely an example, and should not impose any limitation on the functionality and scope of use of the embodiments of the present disclosure.

As shown in FIG. 7, the electronic apparatus 12 is represented in the form of a generic computing device. Components of the electronic apparatus 12 includes, but are not limited to, one or more processors or processing units 16, a memory 28, and a bus 18 connecting different system components (including the memory 28 and the processing unit 16).

The bus 18 represents one or more of several types of bus architectures, including a memory bus or a memory controller, a peripheral bus, a graphics acceleration port, a processor, or a local bus using any of a variety of bus architectures. For example, these architectures include, but are not limited to, an industry standard architecture (hereinafter abbreviated as ISA) bus, a micro channel architecture (hereinafter abbreviated as MAC) bus, an enhanced ISA bus, a video electronics standards association (hereinafter abbreviated as VESA) local bus, and a peripheral component interconnection (hereinafter abbreviated as PCI) bus.

The electronic apparatus 12 typically includes a variety of computer system readable media. These media may be any available medium that may be accessed by the electronic apparatus 12, including volatile and nonvolatile media, and removable and non-removable media.

The memory 28 includes a computer system readable medium in the form of volatile memory, such as a random access memory (hereinafter abbreviated as RAM) 30 and/or a cache 32. The electronic apparatus 12 may further include other removable/non-removable, volatile/nonvolatile computer system storage media. By way of example merely, a storage system 34 is used to read from and write to non-removable, nonvolatile magnetic medium (not shown in FIG. 7, often referred to as a “hard disk drive”).

Although not shown in FIG. 7, a disk drive for reading from and writing to a removable nonvolatile magnetic disk (for example, a “floppy disk”), and an optical disk drive for reading from and writing to a removable nonvolatile optical disk (for example, a compact disc read only memory (hereinafter abbreviated as CD-ROM), a digital video disc read only memory (hereinafter abbreviated as DVD-ROM) or other optical media) may be provided. In these cases, each drive may be connected to the bus 18 through one or more data media interfaces. The memory 28 includes at least one program product, and the at least one program product has a set of (for example, at least one) program modules configured to perform functions of embodiments of the present disclosure.

A program/utility tool 40 having a set of or at least one program module(s) 42 may be stored in the memory 28, for example. Such program modules 42 include, but are not limited to, an operating system, one or more application programs, other program modules and program data, and each or some combination of these examples includes an implementation of a network environment. The program modules 42 generally perform the functions and/or methods in the embodiments described in the present disclosure.

The electronic apparatus 12 may also communicate with one or more external devices 14 (for example, a keyboard, a pointing device, a display 24, etc.), and may also communicate with one or more devices that enable the human body to interact with the electronic apparatus 12, and/or communicate with any device that enables the electronic apparatus 12 to communicate with one or more other computing devices (for example, a network card, a modem, etc.). Such communication may be performed through an input/output (I/O) interface 22. Moreover, the electronic apparatus 12 may communicate with one or more networks (for example, a local area network (hereinafter abbreviated as LAN), a wide area network (hereinafter abbreviated as WAN) and/or a public network, such as the Internet) through a network adapter 20. As shown in FIG. 7, the network adapter 20 communicates with other modules of the electronic apparatus 12 through the bus 18. It should be understood that, although not shown in FIG. 7, other hardware and/or software modules may be used in conjunction with the electronic apparatus 12, including but not limited to: a microcode, a device driver, a redundant processing unit, an external disk drive array, an RAID system, a tape drive, a data backup storage system, and the like.

The processing unit 16 executes various functional applications and data processing by running programs stored in the memory 28, for example, implementing the speech signal processing method mentioned in the above embodiment.

Embodiments of the present disclosure also provide an earphone. The earphone includes a processor, and a memory for storing instructions executable by the processor, in which the processor is configured to implement steps of the method in the above embodiments.

Embodiments of the present disclosure also provide a hearing aid. The hearing aid includes a processor, and a memory for storing instructions executable by the processor, in which the processor is configured to implement steps of the method in the above embodiments.

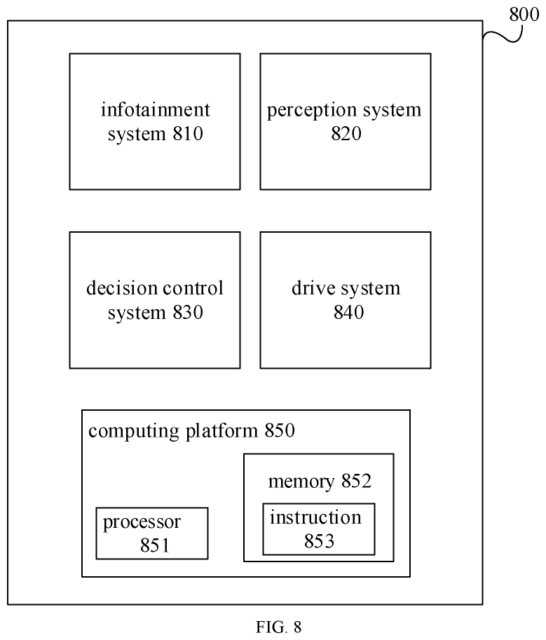

FIG. 8 is a functional block diagram of a vehicle according to an embodiment.

For example, a vehicle 800 may be a hybrid vehicle, a non-hybrid vehicle, an electric vehicle, a fuel cell vehicle, or other types of vehicles. The vehicle 800 may be an autonomous vehicle, a semi-autonomous vehicle, or a non-autonomous vehicle.

Referring to FIG. 8, the vehicle 800 includes various subsystems, such as an infotainment system 810, a perception system 820, a decision control system 830, a drive system 840, and a computing platform 850. The vehicle 800 may also include more or fewer subsystems, and each subsystem includes multiple components. In addition, each subsystem and each component of the vehicle 800 may be interconnected by wired or wireless means.

In some embodiments, the infotainment system 810 includes a communication system, an entertainment system, a navigation system, and the like.

The sensing system 820 includes several kinds of sensors for sensing information of the environment around the vehicle 800. For example, the sensing system 820 includes a global positioning system (which may be a GPS system, a Beidou system, or other positioning systems), an inertial measurement unit (IMU), a laser radar, a millimeter-wave radar, an ultrasonic radar, and an imaging device.

The decision control system 830 includes a computing system, a vehicle controller, a steering system, a throttle, and a braking system.

The drive system 840 includes components that provide power movement for the vehicle 800. In an embodiment, the drive system 840 includes an engine, an energy source, a transmission system, and a wheel. The engine may be one or a combination of an internal combustion engine, an electric motor, and an air compression engine. The engine may convert energy provided by the energy source into mechanical energy.

Some or all functions of the vehicle 800 are controlled by the computing platform 850. The computing platform 850 includes at least one processor 851 and a memory 852. The processor 851 may execute instructions 853 stored in the memory 852.

The processor 851 may be any conventional processor, such as a commercially available CPU. The processor may also include, for example, a graphic process unit (GPU), a field programmable gate array (FPGA), a system on chip (SOC), an application specific integrated circuit (ASIC), or a combination thereof.

The memory 852 may be implemented by any type of volatile or nonvolatile memory device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

In addition to the instructions 853, the memory 852 may also store data, such as a road map, route information, a car position, a direction, a speed, and other data. The data stored in the memory 852 may be used by the computing platform 850.

In the embodiment of the present disclosure, the processor 851 may execute the instructions 853 to complete all or part of the steps of the above-mentioned speech signal processing method.

In order to implement the above embodiments, the present disclosure also provides non-transitory computer-readable storage medium having stored therein computer programs that, when executed by a processor, causes the processor to implement the speech signal processing method in the above embodiments of the present disclosure.

In order to implement the above embodiments, the present disclosure also provides a computer program product including instructions that, when executed by a processor, causes the processor to implement the speech signal processing method in the above embodiments of the present disclosure.

It should be noted that in the description of the present disclosure, terms such as “first” and “second” are used herein for purposes of description and are not intended to indicate or imply relative importance or significance. In addition, in the description of the present disclosure, “a plurality of” means two or more, unless specified otherwise.

Any process or method description in the flowchart or otherwise described herein may be understood as representing a module, segment or part of code that includes one or more executable instructions for implementing the steps of a particular logical function or process, and the scope of the embodiments of the present disclosure includes additional implementations, which may not be in the order shown or discussed. It should be understood by those skilled in the art of the embodiments of the present disclosure that functions are performed in a substantially simultaneous manner or in reverse order according to the functions involved.

It should be understood that the various parts of the present disclosure may be implemented in hardware, software, firmware, or a combination thereof. In the above embodiments, a plurality of steps or methods may be implemented with software or firmware stored in memory and executed by a suitable instruction execution system. For example, when it is implemented by hardware, as in another embodiment, it can be implemented by any one of the following technologies known in the art or their combination: discrete logic circuit with logic gate circuit for realizing logic function on data signal, special integrated circuit with suitable combined logic gate circuit, programmable gate array (PGA), and field programmable gate array (FPGA).

Those skilled in the art can understand that all or part of the steps carried by the method of implementing the above embodiments can be implemented by instructing relevant hardware through a program. The program can be stored in a computer-readable storage medium. When the program is executed, it includes one of or a combination of the steps of the method embodiment.

In addition, each functional unit in each embodiment of the present disclosure can be integrated in a processing module; or each unit can exist physically independently; or two or more units can be integrated in a module. The above integrated modules can be implemented in the form of hardware or software function modules. When the integrated module is realized in the form of a software functional module and is sold or used as an independent product, it can also be stored in a computer readable storage medium.

The storage medium mentioned above may be a read-only memory, a disk or an optical disc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the exemplary descriptions of the above terms throughout this specification are not necessarily referring to the same embodiment or example. Moreover the particular features, structures, materials or characteristic described may be combined in a suitable manner in any one or more embodiments or examples.

Although the embodiments of the present disclosure have been shown and described above, it can be understood that the above embodiments are exemplary and cannot be understood as limitations on the present disclosure, and changes, modifications, alternatives and variations can be made in the above embodiments within the scope of the present disclosure by those skilled in the art.

What is claimed is:

1. A speech signal processing method, comprising:
acquiring a speech observation signal collected by a speech collection device;
pre-separating the speech observation signal to obtain a first pre-separation signal and a second pre-separation signal, wherein a first distance between a sound source of the first pre-separation signal and the speech collection device is different from a second distance between a sound source of the second pre-separation signal and the speech collection device; and
performing blind source separation on the speech observation signal according to the first pre-separation signal to obtain a first source speech signal of the sound source of the first pre-separation signal; and
performing blind source separation on the speech observation signal according to the second pre-separation signal to obtain a second source speech signal of the sound source of the second pre-separation signal.

2. The speech signal processing method according to claim 1, wherein the speech collection device comprises a plurality of speech collection units; the speech observation signal comprises a first speech observation signal collected by a first speech collection unit; the first speech collection unit being a member of the plurality of speech collection units,
wherein pre-separating the speech observation signal to obtain the first pre-separation signal and the second pre-separation signal comprises:
pre-separating the first speech observation signal to obtain a first pre-separation signal and a second pre-separation signal.

3. The speech signal processing method according to claim 2, further comprising:
randomly selecting one speech collection unit from the plurality of speech collection units as the first speech collection unit.

4. The speech signal processing method according to claim 2, wherein pre-separating the first speech observation signal to obtain the first pre-separation signal and the second pre-separation signal comprises:
inputting the first speech observation signal into a pre-separation model to obtain the first pre-separation signal and the second pre-separation signal output by the pre-separation model;
wherein:
the pre-separation model is obtained through deep learning training by using a training set, and the training set comes from the plurality of speech collection units;
the training set comprises a plurality of samples, and one speech collection unit corresponds to at least one sample, each sample of the at least one sample comprising: a sample observation signal collected by the speech collection unit, and a first sample speech signal and a second sample speech signal both corresponding to the sample observation signal; and
a third distance between a sound source of the first sample speech signal and the speech collection unit is different from a fourth distance between a sound source of the second sample speech signal and the speech collection unit.

5. The speech signal processing method according to claim 1, wherein performing the blind source separation on the speech observation signal according to the first pre-separation signal to obtain the first source speech signal of the sound source of the first pre-separation signal comprises:
determining a variance term of a probability density function of a sound source corresponding to the speech observation signal;
taking the first pre-separation signal as a pilot signal of the variance term of the probability density function of the sound source to obtain the variance term of the probability density function of the sound source into which the pilot signal is introduced;
performing blind source separation on the speech observation signal according to a first separation matrix to obtain an initial separation signal frequency vector;
determining a first separation signal frequency vector according to the initial separation signal frequency vector, the variance term of the probability density function of the sound source into which the pilot signal is introduced, and the first separation matrix; and
determining the first source speech signal according to the first separation signal frequency vector.

6. The speech signal processing method according to claim 5, wherein determining the first separation signal frequency vector according to the initial separation signal frequency vector, the variance term of the probability density function of the sound source into which the pilot signal is introduced, and the first separation matrix, comprises:
taking the initial separation signal frequency vector as the first separation signal frequency vector, in case that the initial separation signal frequency vector satisfies a preset condition;
updating a reference term according to the first separation matrix and acquiring an updated reference term, in case that the initial separation signal frequency vector does not satisfy the preset condition, wherein the reference term comprises the variance term of the probability density function of the sound source into which the pilot signal is introduced, and the first separation matrix is related to the initial reference term; and
determining a second separation matrix according to the updated reference term; performing blind source separation on the speech observation signal according to the second separation matrix until a separation signal frequency vector obtained by the blind source separation satisfies the preset condition; and taking the separation signal frequency vector obtained as the first separation signal frequency vector.

7. The speech signal processing method according to claim 1, wherein performing the blind source separation on the speech observation signal according to the second pre-separation signal to obtain the second source speech signal of the sound source of the second pre-separation signal, comprises:
determining a variance term of a probability density function of a sound source corresponding to the speech observation signal;
taking the second pre-separation signal as a pilot signal of the variance term of the probability density function of the sound source to obtain the variance term of the probability density function of the sound source into which the pilot signal is introduced;
performing blind source separation on the speech observation signal according to a first separation matrix to obtain an initial separation signal frequency vector;
determining a second separation signal frequency vector according to the initial separation signal frequency vector, the variance term of the probability density function of the sound source into which the pilot signal is introduced, and the first separation matrix; and
determining the second source speech signal according to the second separation signal frequency vector.

8. The speech signal processing method according to claim 7, wherein determining the second separation signal frequency vector according to the initial separation signal frequency vector, the variance term of the probability density function of the sound source into which the pilot signal is introduced, and the first separation matrix, comprises:
taking the initial separation signal frequency vector as the second separation signal frequency vector, in case that the initial separation signal frequency vector satisfies a preset condition;
updating a reference term according to the first separation matrix and acquiring an updated reference term, in case that the initial separation signal frequency vector does not satisfy the preset condition, wherein the reference term comprises the variance term of the probability density function of the sound source into which the pilot signal is introduced, and the first separation matrix is related to the initial reference term; and
determining a second separation matrix according to the updated reference term; performing blind source separation on the speech observation signal according to the second separation matrix until a separation signal frequency vector obtained by the blind source separation satisfies the preset condition; and taking the separation signal frequency vector obtained as the second separation signal frequency vector.

9. An electronic apparatus, comprising:
at least one processor; and
a memory in communication with the at least one processor,
wherein the memory stores instructions executable by the at least one processor, and the instructions are executed by the at least one processor to allow the at least one processor to:
acquire a speech observation signal collected by a speech collection device;
pre-separate the speech observation signal to obtain a first pre-separation signal and a second pre-separation signal, wherein a first distance between a sound source of the first pre-separation signal and the speech collection device is different from a second distance between a sound source of the second pre-separation signal and the speech collection device; and
perform blind source separation on the speech observation signal according to the first pre-separation signal to obtain a first source speech signal of the sound source of the first pre-separation signal; and
perform blind source separation on the speech observation signal according to the second pre-separation signal to obtain a second source speech signal of the sound source of the second pre-separation signal.

10. The electronic apparatus according to claim 9, wherein the speech collection device comprises a plurality of speech collection units; the speech observation signal comprises a first speech observation signal collected by a first speech collection unit; and the first speech collection unit being a member of the plurality of speech collection units,
the at least one processor is configured to pre-separate the first speech observation signal to obtain a first pre-separation signal and a second pre-separation signal.

11. The electronic apparatus according to claim 10, wherein the at least one processor is configured to input the first speech observation signal into a pre-separation model to obtain the first pre-separation signal and the second pre-separation signal output by the pre-separation model,
wherein:
the pre-separation model is obtained through deep learning training by using a training set, and the training set comes from the plurality of speech collection units;
the training set comprises a plurality of samples, and one speech collection unit corresponds to at least one sample, each sample of the at least one sample comprising: a sample observation signal collected by the speech collection unit, and a first sample speech signal and a second sample speech signal both corresponding to the sample observation signal; and
a third distance between a sound source of the first sample speech signal and the speech collection unit is different from a fourth distance between a sound source of the second sample speech signal and the speech collection unit.

12. The electronic apparatus according to claim 9, wherein the at least one processor is configured to:
determine a variance term of a probability density function of a sound source corresponding to the speech observation signal;
take the first pre-separation signal as a pilot signal of the variance term of the probability density function of the sound source to obtain the variance term of the probability density function of the sound source into which the pilot signal is introduced;
perform blind source separation on the speech observation signal according to a first separation matrix to obtain an initial separation signal frequency vector;
determine a first separation signal frequency vector according to the initial separation signal frequency vector, the variance term of the probability density function of the sound source into which the pilot signal is introduced, and the first separation matrix; and
determine the first source speech signal according to the first separation signal frequency vector.

13. The electronic apparatus according to claim 12, wherein the at least one processor is configured to:
take the initial separation signal frequency vector as the first separation signal frequency vector, in case that the initial separation signal frequency vector satisfies a preset condition;
update a reference term according to the first separation matrix and acquire an updated reference term, in case that the initial separation signal frequency vector does not satisfy the preset condition, wherein the reference term comprises the variance term of the probability density function of the sound source into which the pilot signal is introduced, and the first separation matrix is related to the initial reference term; and
determine a second separation matrix according to the updated reference term; perform blind source separation on the speech observation signal according to the second separation matrix until a separation signal frequency vector obtained by the blind source separation satisfies the preset condition; and take the separation signal frequency vector obtained as the first separation signal frequency vector.

14. The electronic apparatus according to claim 9, wherein the at least one processor is configured to:
determine a variance term of a probability density function of a sound source corresponding to the speech observation signal;
take the second pre-separation signal as a pilot signal of the variance term of the probability density function of the sound source to obtain the variance term of the probability density function of the sound source into which the pilot signal is introduced;
perform blind source separation on the speech observation signal according to a first separation matrix to obtain an initial separation signal frequency vector;
determine a second separation signal frequency vector according to the initial separation signal frequency vector, the variance term of the probability density function of the sound source into which the pilot signal is introduced, and the first separation matrix; and
determine the second source speech signal according to the second separation signal frequency vector.

15. The electronic apparatus according to claim 14, wherein the at least one processor is configured to:
take the initial separation signal frequency vector as the second separation signal frequency vector, in case that the initial separation signal frequency vector satisfies a preset condition;
update a reference term according to the first separation matrix and acquire an updated reference term, in case that the initial separation signal frequency vector does not satisfy the preset condition, wherein the reference term comprises the variance term of the probability density function of the sound source into which the pilot signal is introduced, and the first separation matrix is related to the initial reference term; and
determine a second separation matrix according to the updated reference term; perform blind source separation on the speech observation signal according to the second separation matrix until a separation signal frequency vector obtained by the blind source separation satisfies the preset condition; and take the separation signal frequency vector obtained as the second separation signal frequency vector.

16. An earphone, comprising:
a processor; and
a memory for storing instructions executable by the processor;
wherein the processor is configured to:
acquire a speech observation signal collected by a speech collection device;
pre-separate the speech observation signal to obtain a first pre-separation signal and a second pre-separation signal, wherein a first distance between a sound source of the first pre-separation signal and the speech collection device is different from a second distance between a sound source of the second pre-separation signal and the speech collection device; and
perform blind source separation on the speech observation signal according to the first pre-separation signal to obtain a first source speech signal of the sound source of the first pre-separation signal; and
perform blind source separation on the speech observation signal according to the second pre-separation signal to obtain a second source speech signal of the sound source of the second pre-separation signal.

17. A hearing aid, comprising:
a processor; and
a memory for storing instructions executable by the processor;
wherein the processor is configured to implement steps in the speech signal processing method according to claim 1.

18. A vehicle, comprising:
a processor; and
a memory for storing instructions executable by the processor;
wherein the processor is configured to implement steps in the speech signal processing method according to claim 1.

19. A non-transitory computer-readable storage medium having stored therein computer instructions that cause a computer to implement the speech signal processing method according to claim 1.

20. A computer program product comprising a computer program that, when executed by a processor, implements the speech signal processing method according to claim 1.
